(19) United States
(12) Patent Application Publication
(10) Pub. No.: US 2016/0073172 A1
(43) Pub. Date: Mar. 10, 2016

(54) BROADCAST EVENT NOTIFICATIONS

(71) Applicant: EchoStar UK Holdings Limited, Keighley (GB)

(72) Inventor: Christian Sharples, Steeton (GB)

(21) Appl. No.: 14/479,007

(22) Filed: Sep. 5, 2014

(51) Int. Cl. H04N 21/488; H04N 21/858; H04N 21/482; H04N 21/41; H04N 21/422

(52) U.S. Cl. CPC H04N 21/4882; H04N 21/4126; H04N 21/4222; H04N 21/4821; H04N 21/4828; H04N 21/858

(57) ABSTRACT

Systems and methods for alerting a mobile device about a broadcast television event include pairing a mobile device with a television receiver to establish a local wireless connection between the mobile device and the television receiver. An event selection is received at the television receiver. The event selection is indicative of a program title related to a broadcast program to be alerted to the mobile device. After the television receiver determines that threshold time prior to the broadcast time of the event selection has been reached, the television receiver alerts the mobile device through the local wireless connection.

### BACKGROUND

Typically, television shows are broadcast at specific broadcast times according to a schedule that is determined by a service provider. Television viewers must be aware of the broadcast time for a specific show that they intend to watch. Sometimes, a viewer may forget that a particular show is being broadcast. Other times, the viewer may lose track of time and miss the broadcast. In other cases, the viewer may be interested in watching a particular show or movie, but is unaware of the broadcast time. In any of the above cases, the television viewer may forego an opportunity to view the show. This disclosure is intended to address the above-noted concerns and to provide related advantages.

### SUMMARY

In one aspect, the disclosure provides a television receiver for alerting a mobile device about a broadcast television event. The television receiver comprises one or more processors and a memory communicatively coupled with and readable by the one or more processors. The memory has stored therein processor-readable instructions that, when executed by the one or more processors, cause the one or more processors to receive an identification number of the mobile device to be alert and receive an event selection, wherein the event selection is indicative of a program title related to a broadcast program to be alerted to the mobile device. In some aspects, the television receiver further determines a broadcast time and a broadcast channel of the broadcast program, wherein a program stream of the broadcast program is scheduled to be received at the broadcast channel during the broadcast time. Still further, the television receiver may determine that a threshold time prior to the broadcast time has been reached and after determining that the threshold time has been reached, may alert the mobile device with 1) a message indicating that the broadcast program is about to start and 2) a request for user input from the mobile device. After alerting the mobile device, the television receiver may receive the user input from the mobile device, and after receiving the user input, the television receiver may manage output of the broadcast program based on the user input.

Embodiments detailed herein may have one or more of the following features. The mobile device may comprise a mobile phone and/or a tablet computer. The television receiver may receive a plurality of identification numbers for a plurality of mobile devices, wherein the plurality of identification numbers are associated with a user profile, and after determining that the threshold time has been reached, the television receiver may alert the plurality of mobile devices associated with the user profile. Further, the television receiver may determine the broadcast time of the broadcast program by looking up at least a portion of the received event selection in an electronic program guide, display a plurality of broadcast times for the event selection, and receive a user selection for at least one of the plurality of the displayed broadcast times for alerting the mobile device. The television receiver may receive a subtitle related to the broadcast program in the event selection and look up at least one of the program title and the subtitle in the electronic program guide. In another aspect, the television receiver may receive a user selection for the threshold time, wherein the threshold time is a duration of time immediately preceding the broadcast time. In yet another aspect, the television receiver may receive an output command selected in the user input, receive a display device selection in the user input, tune to the broadcast channel to receive the program stream at the broadcast time, and output the broadcast program on the selected display device.

In other aspects, the television receiver may determine that the broadcast channel is not being output on a display device coupled to the television receiver during the threshold time, and after determining that the display device is not displaying the broadcast channel, alert, by the television receiver, the mobile device based on the determination that the display device is not displaying the broadcast channel. The display device may be a predetermined display device based on a previous user input. Still further, the television receiver may send a second alert to the mobile device if no user input is received once the broadcast time is reached, wherein the second alert comprises an updated message indicating that the broadcast program has started, and manage output of the broadcast program based on a default mode, wherein the default mode is a predetermined operation based on a previous user input. Even further, the television receiver may alert the mobile device at the identification number through a Bluetooth or wireless connection. Still further, the television receiver may receive a plurality of identification numbers corresponding to a plurality of mobile devices, rank the plurality of mobile devices based on a user-determined priority, alert the plurality of mobile devices after determining that the threshold time has been reached, receive the user input from at least one of the plurality of mobile devices, and manage output of the broadcast program based on the user input received from a highest-ranking mobile device.

In another aspect, the disclosure provides a method for alerting a mobile device about a broadcast television event. The method includes establishing, by a television receiver, a communication link with a mobile device, wherein the communication link comprises a local wireless connection between the mobile device and the television receiver. The method further includes receiving, by the television receiver, an event selection, wherein the event selection is indicative of a program title related to a broadcast program to be alerted to the mobile device. Further, the method includes determining that a threshold time prior to a broadcast time of the event selection has been reached. After determining that the threshold time prior to the broadcast time has been reached, the method may include alerting the mobile device through the local wireless connection.

Embodiments detailed herein may have one or more of the following features. The method may comprise after determining that the threshold time prior to the broadcast time has been reached, determining, by the television receiver, that a tuner of the television receiver is already tuned to a broadcast channel containing the broadcast program. The method may further comprise after determining that the threshold time prior to the broadcast program has been reached, determining, by the television receiver, that a display device coupled to the television receiver is not displaying a broadcast channel scheduled to display the broadcast program at a broadcast time, and after determining that the display device is not displaying the broadcast program, alerting, by the television receiver, the mobile device based on the determination that the display device is not displaying the broadcast channel. Still further, the method may comprise outputting, by the television receiver, a user interface for presentation on a display device coupled to the television receiver, wherein the user interface comprises an even selection list including an upcoming event selection, a previously alerted event selection, and a recommended broadcast event selection.

In another aspect, the disclosure provides a non-transitory processor-readable medium for alerting a mobile device about a broadcast event. The non-transitory processor-readable medium comprises processor-readable instructions configured to cause one or more processors to receive an identification number of the mobile device to be alerted. The processor-readable instructions are further configured to receive an event selection, wherein the event selection is indicative of a program title related to a broadcast program to be alerted to the mobile device. Further, the process-readable instructions are configured to determine a broadcast time and a broadcast channel of the broadcast program, wherein a program stream of the broadcast program is scheduled to be received at the broadcast channel during the broadcast time. The processor-readable instructions may further be configured to determine that a threshold time prior to the broadcast time has been reached, and after determining that the threshold time has been reached, alert the mobile device with 1) a message indicating that the broadcast program is about to start and 2) a request for user input from the mobile device. In another aspect, the processor-readable instructions may be configured to receive, after alerting the mobile device, the user input from the mobile device and after receiving the user input, manage output of the broadcast program based on the user input.

Embodiments detailed herein may have one or more of the following features. The non-transitory processor-readable medium may receive a user input through the mobile device to select a display device from a plurality of display devices for displaying the broadcast channel. Further, the non-transitory processor-readable medium may detect that the broadcast program is related to a series of broadcast programs, and provide a series link for the series of broadcast programs, wherein the series link establishes recurring notifications for the series of broadcast programs. Further, the non-transitory processor-readable medium may determine, after determining that the threshold time has been reached, that a display device coupled to the television receiver is not displaying the broadcast channel, and after determining that the display device is not displaying the broadcast channel, alert the mobile device based on the determination that the display device is not displaying the broadcast channel.

### BRIEF DESCRIPTION OF THE DRAWINGS

FIG. 1 shows an example method for a broadcast event notification that may be performed by an alerting module and/or other various embodiments of the present disclosure;

FIG. 2 shows an example satellite system having a television receiver with the alerting module of FIG. 1;

FIG. 3 shows an example block diagram for the television receiver having the alerting module of FIG. 2;

FIG. 4 shows another example method for broadcast event notifications and managing output of a broadcast program that may be performed by various embodiments of the present disclosure;

FIG. 5 shows an example user interface that may be provided on a mobile device in communication with the television receiver of FIG. 2;

FIG. 6 shows another example user interface that may be provided on a display device coupled to the television receiver of FIG. 2; and

FIG. 7 shows an example computing system.

### DETAILED DESCRIPTION

The present disclosure is directed to systems and methods for notifying a mobile device that a broadcast television event, such as a show or movie, is about to air. More particularly, the disclosure provides a broadcast event notification system and method for receiving event selections from a user through a mobile device, a television receiver, and/or any other computing device coupled with a television receiver having an alerting module described herein. Merely by way of example, an event selection may be a title or other identification tag for a particular movie, recurring television series, specific television episode, genre of media content, and so on. In another aspect, the disclosure provides for a television receiver that is communicatively paired with a mobile device of a user to establish a bidirectional communication with the mobile device through a local area network and/or protocol. Such pairings may implement various wireless technology networks for exchanging data over short distances, such as Bluetooth, and/or a local wireless internet signal. In yet another aspect, the television receiver may ping or notify the mobile device when the event selections are about to occur to inform the user that the selected media content is about to start, e.g. a stream of the desired media content will become available for reception by the television receiver momentarily. Still further, the television receiver described herein may receive user input for commands and/or control through the mobile device, and based on the user input, the television receiver can manage output of the media content. For instance, the television receiver may, merely by way of example, record, pause, skip, and/or display the media content on a particular display device.

In practice, the broadcast event notification system described herein may prevent missed opportunities for viewing desired media content. In an aspect, the system and method described herein may remind and inform a user's mobile device when the desired media content is about to become available for output, e.g. when a broadcast time for the desired media content is approaching. In another aspect, the system and method determines a broadcast time for specific shows and/or movies, and or genres thereof, of interest to the user and automatically notifies the user's mobile device when such broadcast times are approaching. In still another aspect, the system and method may provide greater convenience to the user by permitting remote control of the television receiver through the mobile device, which may comprise a mobile phone, laptop, tablet computer, computer, and/or any other device that can be communicatively paired to the television receiver. For instance, a person located upstairs may command a downstairs television receiver to output a children's show for younger viewers located downstairs through the person's mobile device. Other benefits and related advantages are described below.

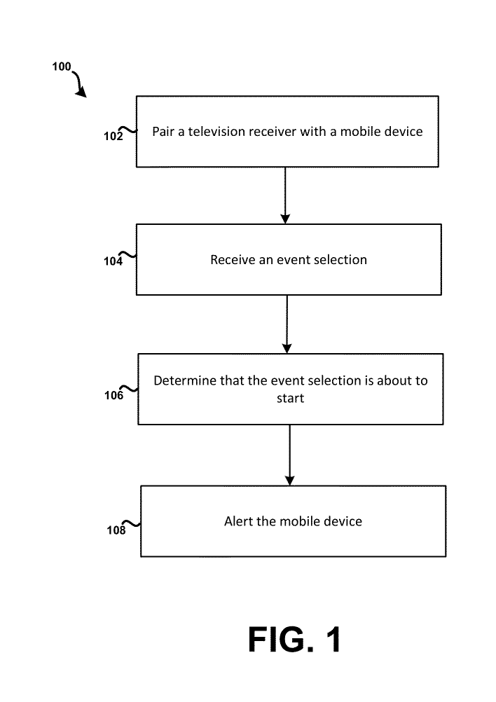

FIG. 1 shows a method 100 of the broadcast event notification system that may be performed by one or more components of the television receiver, such as by the alerting module of the television receiver as described in the succeeding paragraphs. The method 100 may comprise pairing the television receiver with a mobile device (step 102). For instance, pairing may include establishing, by the television receiver, a communication link with the mobile device, whereby the communication link comprises a local wireless connection between the mobile device and the television receiver. A plurality of mobile devices may be paired with the television receiver at any time. Further, the television receiver may be paired to each mobile device only once and future connections may be established automatically. For instance, the alerting module may instruct the television receiver to scan for other Bluetooth-enabled mobile devices in an area. When a mobile device is discovered for a first time, the alerting module may prompt the mobile device for a specific passkey and/or other details to be exchanged. Such details may be stored by the alerting module so that future pairing attempts may be performed automatically when the specific mobile device is detected by the television receiver to be within range. For instance, future pairing attempts may be performed without requiring user input, e.g. without requiring the user to enter a passkey each time. In a different aspect, a user may request that the pairing details not be saved by the alerting module and/or the television receiver as a security precaution. Such pairing details may include passkey information, mobile device phone number, other identification numbers, preferences for automatic pairing, and so on.

The method 100 may further comprise receiving an event selection (step 104). The event selection may comprise a program title related to a broadcast program that the user desires to be alerted about. The event selection may further comprise a subtitle, such as an episode title for a broadcast program that is related to a series of broadcast programs, such as a television series comprising a plurality of episodes. In another example, the event selection comprises an identification number and/or code that is indicative of the desired broadcast program. In further aspects, the event selection may include a specific broadcast time for the broadcast program that is entered and/or selected by user input. In a different example, the alerting module may instruct the television receiver to determine one or more broadcast times by looking up titles, subtitles, and/or identification in a database provided by a service provider, such as an electronic programming guide. Still, in further aspects, the user may input credit card or account payment information to prepay or set up payment for a movie or showing.

Still further, the method 100 may comprise determining that the event selection is about to start (step 106), e.g. the broadcast time for the broadcast program is approaching. In some examples, the alerting module of the television receiver may determine that a threshold time has been reached prior to the broadcast time. Merely by way of example, the threshold time may be between about 5 to about 15 minutes immediately prior to the broadcast time, such that a broadcast time of 12:00 pm may have a threshold time that is reached at 11:45 am if a 15-minute threshold time period is selected. At that time, the alerting module determines that the event selection is “about to start,” e.g. the desired media content will become available and/or received at the approaching broadcast time. It is contemplated that the threshold time may be any duration of time that is set by user input through any computing device. Further, each event selection may have a different threshold time as determined by the user input, and/or each event selection may have more than one threshold time to provide for a reminder or snooze feature. Merely by way of example, a user may set a longer threshold time, such as one hour, for an event selection comprising a one-time showing of a movie. On the other hand, the user may set shorter threshold times, such as a five minutes, for event selections comprising recurring events, e.g. a weekly television show, since the user may not want or need greater advance notice. Other options are possible.

In yet a further aspect, the method 100 comprises alerting the mobile device (step 108) about the event selection. Merely by way of example, the alerting module of the television receiver may communicate a message through Bluetooth or other connection established at step 102 to the mobile device that the broadcast television program is about to start. Further, alerting may include prompting or requesting user input from the mobile device(s) being alerted. For instance, the television receiver may wait to receive user input instructions regarding recording, skipping, displaying, and so on, prior to implementing any further actions. In another aspect, the television receiver may not be tuned to receive the desired stream of media content until prompted by the user input. In this way, the alerting module manages output of the broadcast program based on the user input that is received in response to the alert. Other steps are possible.

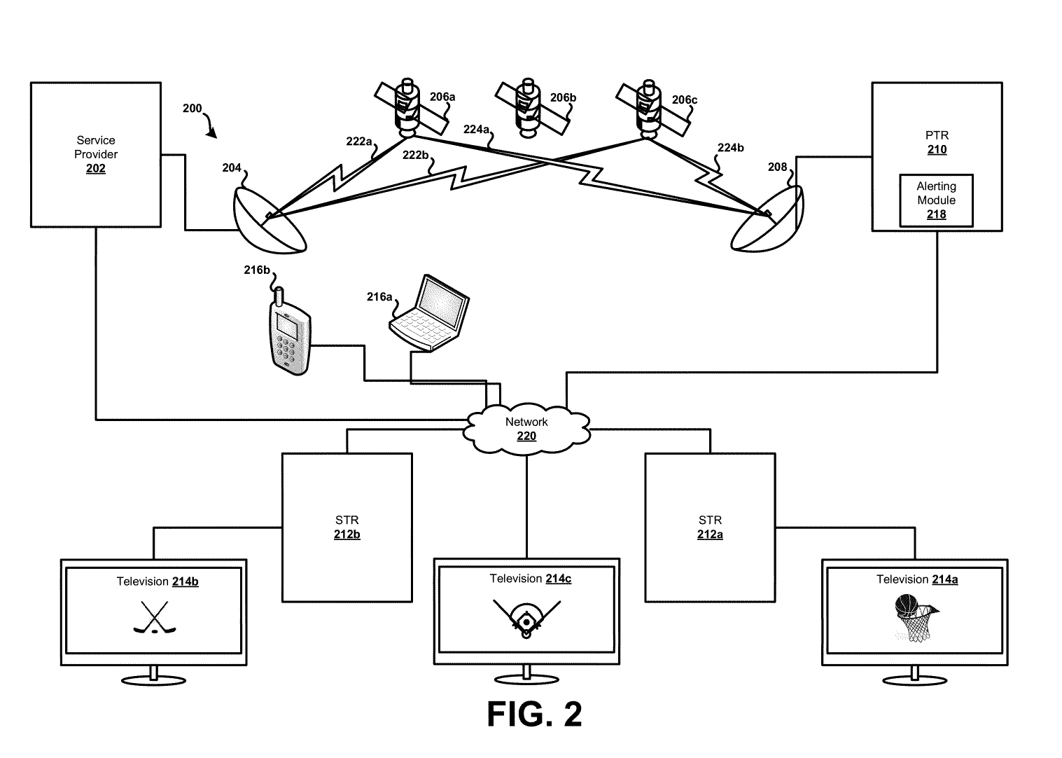

Turning now to FIG. 2, an example satellite system 200 is shown in accordance with the present disclosure. For brevity, the satellite system 200 is depicted in a simplified form, and may generally include more or fewer systems, devices, networks, and/or other components as desired. Further, number and type of features or elements incorporated within the satellite system 200 may or may not be implementation-specific, and at least some of the aspects of the satellite system 200 may be similar to a cable television distribution system, an IPTV (Internet Protocol Television) content distribution system, and/or any other type of content distribution system.

In this example, the satellite system 200 may include a service provider 202, a satellite uplink 204, a plurality of orbiting (e.g., geosynchronous) satellites 206a-c, a satellite dish 208, a PTR (Primary Television Receiver) 210, a plurality of STRs (Secondary Television Receivers) 212a-b, a plurality of televisions 214a-c, and a plurality of computing devices 216a-b. The PTR 210 may include an alerting module 218 that is programmatically configured to notify a mobile device that a broadcast event is about to occur. As discussed throughout, the alerting module 218 may be provided according to a particular hardware and/or firmware architecture of the PTR 210. Such implementations may be beneficial and/or advantageous in many respects, as described further in the succeeding paragraphs.

The satellite system 200 may also include at least one network 220 that establishes a bi-directional communication path for data transfer between and among each respective element of the satellite system 200 outside of the unidirectional satellite signaling path. The network 220 is intended to represent any number of terrestrial and/or non-terrestrial network features or elements. For example, the network 220 may incorporate or exhibit any number of features or elements of various wireless and/or hardwired packet-based communication networks such as, for example, a WAN (Wide Area Network) network, a HAN (Home Area Network) network, a LAN (Local Area Network) network, a WLAN (Wireless Local Area Network) network, the Internet, a cellular communications network, or any other type of communication network configured such that data may be transferred between and among respective elements of the satellite system 200.

The PTR 210, and the STRs 212a-b, as described throughout may generally be any type of television receiver, television converter, etc., such as a STB (Set-Top-Box) for example. In another example, the PTR 210, and the STRs 212a-b, may exhibit functionality integrated as part of or into a television, a DVR, a computer such as a tablet computing device, or any other computing system or device, as well as variations thereof. For instance, functionality of the PTR 210 described herein having the alerting module may be functionally provided in a STB and/or built into, or otherwise installed, in a television itself. Further, the PTR 210 and the network 220, together with the STRs 212a-b and televisions 214a-c, and possibly the computing devices 216a-b, may be incorporated within or form at least a portion of a particular home computing network, and may each be respectively configured so as to enable communications in accordance with any particular communication protocol(s) and/or standard(s) including, for example, TCP/IP (Transmission Control Protocol/Internet Protocol), DLNA/DTCP-IP (Digital Living Network Alliance/Digital Transmission Copy Protection over Internet Protocol), HDMI/HDCP (High-Definition Multimedia Interface/High-bandwidth Digital Content Protection), etc. Other examples are possible. For example, one or more of the various elements or components of the example satellite system 200 may be configured to communicate in accordance with the MoCA® (Multimedia over Coax Alliance) home entertainment networking standard. Still other examples are possible.

In practice, the satellites 206a-c may each be configured to receive uplink signals 222a-b from the satellite uplink 204. In this example, the uplink signals 222a-b may contain one or more transponder streams of particular data or content, such as particular television channel, that is supplied by the service provider 202. For example, each of the respective uplink signals 222a-b may contain various media content such a plurality of encoded HD (High Definition) television channels, various SD (Standard Definition) television channels, on-demand programming, programming information, and/or any other content in the form of at least one transponder stream, and in accordance with an allotted carrier frequency and bandwidth. In this example, different media content may be carried using different ones of the satellites 206a-c. Further, different media content may be carried using different transponders of a particular satellite (e.g., satellite 206a); thus, such media content may be transmitted at different frequencies and/or different frequency ranges. For example, a first and second television channel may be carried on a first carrier frequency over a first transponder of satellite 206a, and a third, fourth, and fifth television channel may be carried on second carrier frequency over a first transponder of satellite 206b, or, the third, fourth, and fifth television channel may be carried on a second carrier frequency over a second transponder of satellite 206a, and etc.

The satellites 206a-c may further be configured to relay the uplink signals 222a-b to the satellite dish 208 as downlink signals 224a-b. Similar to the uplink signals 222a-b, each of the downlink signals 224a-b may contain one or more transponder streams of particular data or content, such as various encoded and/or at least partially electronically scrambled television channels, on-demand programming, etc., in accordance with an allotted carrier frequency and bandwidth. The downlink signals 224a-b, however, may not necessarily contain the same or similar content as a corresponding one of the uplink signals 222a-b. For example, the uplink signal 222a may include a first transponder stream containing at least a first group or grouping of television channels, and the downlink signal 224a may include a second transponder stream containing at least a second, different group or grouping of television channels. In other examples, the first and second group of television channels may have one or more television channels in common. In sum, there may be varying degrees of correlation between the uplink signals 222a-b and the downlink signals 224a-b, both in terms of content and underlying characteristics.

Continuing with the example implementation-specific scenario, the satellite dish 208 may be provided for use to receive television channels (e.g., on a subscription basis) provided by the service provider 202, satellite uplink 204, and/or satellites 206a-c. For example, the satellite dish 208 may be configured to receive particular transponder streams, or downlink signals 224a-b, from one or more of the satellites 206a-c. Based on the characteristics of the PTR 210 and/or satellite dish 208, however, it may only be possible to capture transponder streams from a limited number of transponders concurrently. For example, a tuner of the PTR 210 may be configured to tune to a single transponder stream from a transponder of a single satellite at a time.

Additionally, the PTR 210, which is communicatively coupled to the satellite dish 208, may subsequently select via tuner, decode, and relay particular transponder streams to the television 214c for display thereon. For example, the satellite dish 208 and the PTR 210 may, respectively, be configured to receive, decode, and relay at least one premium HD-formatted television channel to the television 214c. Programming or content associated with the HD channel may generally be presented live, or from a recording as previously stored on, by, or at the PTR 210. In this example, the HD channel may be output to the television 214c in accordance with the HDMI/HDCP content protection technologies. Other examples are possible.

Further, the PTR 210 may select via tuner, decode, and relay particular transponder streams to one or both of the STRs 212a-b, which may in turn relay particular transponder streams to a corresponding one of the television 214a and the television 214b for display thereon. For example, the satellite dish 208 and the PTR 210 may, respectively, be configured to receive, decode, and relay at least one television channel to the television 214a by way of the STR 212a. Similar to the above-example, the television channel may generally be presented live, or from a recording as previously stored on the PTR 210, and may be output to the television 214a by way of STR 212a in accordance with a particular content protection technology and/or networking standard. Still further, the satellite dish 208 and the PTR 210 may, respectively, be configured to receive, decode, and relay at least one premium television channel to one or both of the computing devices 216a-b. Similar to the above-examples, the television channel may generally be presented live, or from a recording as previously stored on the PTR 210, and may be output to one or both of the computing devices 216a-b in accordance with a particular content protection technology and/or networking standard.

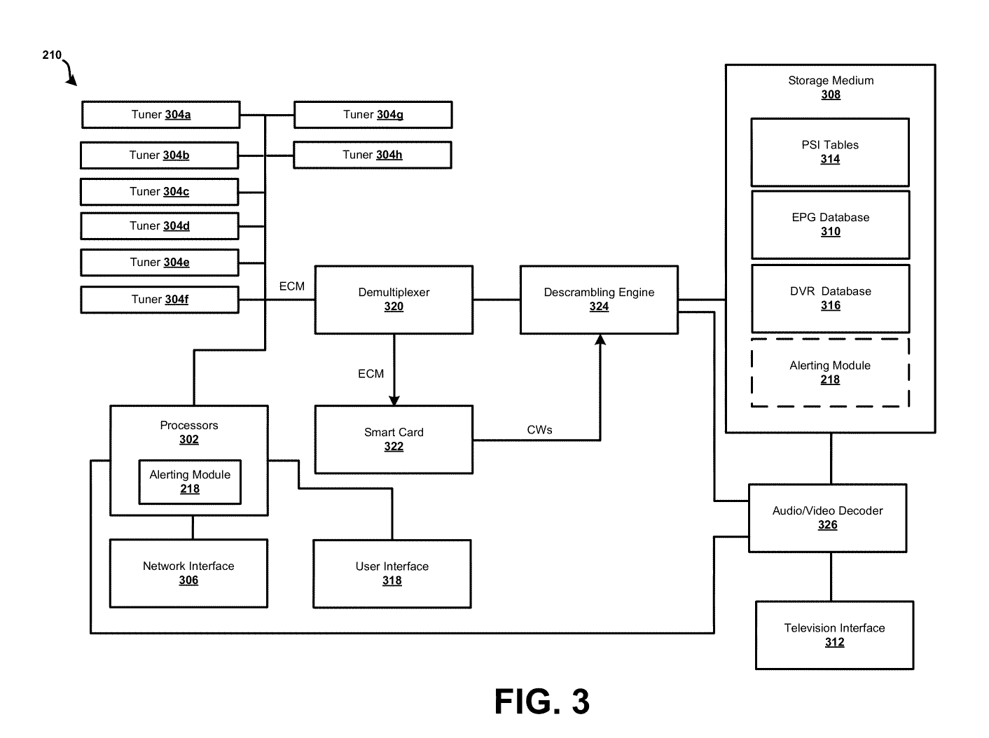

Referring now to FIG. 3, an example block diagram of the PTR 210 of FIG. 2 is shown in accordance with the present disclosure. In some examples, at least one of the STRs 212a-b may be configured in a manner similar to that of the PTR 210. In other examples, at least one of the STRs 212a-b may be configured to exhibit a reduced functionality as compared to the PTR 210, and may depend at least to a certain degree on the PTR 210 to implement certain features or functionality. In this example, the STRs 212a-b may be referred to as a “thin client.”

For brevity, the PTR 210 is depicted in a simplified form, and may generally include more or fewer elements or components as desired in accordance with the present disclosure. For example, the PTR 210 is shown in FIG. 3 to include the alerting module 218. In general, and as discussed in further detail below, the alerting module 218 may be configured to provide for one or more aspects of notifying a mobile device that a broadcast event is about to occur. Other examples are possible as well. For instance, the alerting module 218 and/or functions of the alerting module 218 may be provided by one or more of the computing devices 216a-b by incorporating software and/or other processor-readable instructions, or processors, related to the alerting module 218 into the computing devices 216a-b.

Additionally, although not explicitly shown in FIG. 3, the PTR 210 may include one or more logical modules configured to implement a television steaming media functionality that encodes video into a particular format for transmission over the Internet such as to allow users to remotely view and control a home cable, satellite, or personal video recorder system from an Internet-enabled computer with a broadband Internet connection. The Slingbox® by Sling Media, Inc. of Foster City, Calif., is one example of a product that implements such functionality. Additionally, the PTR 210 may be configured to include any number of other various components or logical modules that are implemented in hardware, software, firmware, or any combination thereof, and such components or logical modules may or may not be implementation-specific.

Referring still to FIG. 3, the PTR 210 in this example includes one or more processors 302, a plurality of tuners 304a-h, at least one network interface 306, at least one non-transitory computer-readable storage medium 308, at least one EPG database 310, at least one television interface 312, at least one PSI (Program Specific Information) table 314, at least one DVR database 316, at least one user interface 318, at least one demultiplexer 320, at least one smart card 322, at least one descrambling engine 324, and at least one decoder 326. In other examples, fewer or greater numbers of components may be present. Further, functionality of one or more components may be combined; for example, functions of the descrambling engine 324 may be performed by the processors 302. Still further, functionality of components may be distributed among additional components, and possibly additional systems such as, for example, in a cloud-computing implementation.

The processors 302 may include one or more specialized and/or general-purpose processors configured to perform processes such as tuning to a particular channel, accessing and displaying EPG information, and/or receiving and processing input from a user. For example, the processors 302 may include one or more processors dedicated to decoding video signals from a particular format, such as according to a particular MPEG (Motion Picture Experts Group) standard, for output and display on a television, and for performing or at least facilitating decryption or descrambling. Furthermore, one or more processors 302 may execute and/or include all or portions of the alerting module 218.

The tuners 304a-h may be used to tune to television channels, such as television channels transmitted via satellites (not shown). Each one of the tuners 304a-h may be capable of receiving and processing a single stream of data from a satellite transponder, or a cable RF channel, at a given time. As such, a single tuner may tune to a single transponder or, for a cable network, a single cable channel. Additionally, one tuner (e.g., tuner 304a) may be used to tune to a television channel on a first transponder stream for display using a television, while another tuner (e.g., tuner 304b) may be used to tune to a television channel on a second transponder for recording and viewing at some other time. If multiple television channels transmitted on the same transponder stream are desired, a particular tuner (e.g., tuner 304c) may be used to receive the signal containing the multiple television channels for presentation and/or recording of each of the respective multiple television channels, such as in a PTAT (Primetime Anytime) implementation for example. Although eight tuners are shown, the PTR 210 may include more or fewer tuners (e.g., three tuners, twelve tuners, etc.), and the features of the disclosure may be implemented similarly and scale according to the number of tuners of the PTR 210.

The network interface 306 may be used to communicate via alternate communication channel(s) with a service provider. For example, the primary communication channel between the service provider 202 of FIG. 2 and the PTR 210 may be via satellites, which may be unidirectional to the PTR 210, and another communication channel between the service provider 202 and the PTR 210, which may be bidirectional, may be via a network, such as various wireless and/or hardwired packet-based communication networks, including, for example, a WAN (Wide Area Network), a HAN (Home Area Network), a LAN (Local Area Network), a WLAN (Wireless Local Area Network), the Internet, a cellular network, a home automation network, or any other type of communication network configured such that data may be transferred between and among respective elements of the satellite system 200. In general, various types of information may be transmitted and/or received via the network interface 306.

The storage medium 308 may represent a non-transitory computer-readable storage medium. The storage medium 308 may include memory and/or a hard drive. The storage medium 308 may be used to store information received from one or more satellites and/or information received via the network interface 306. For example, the storage medium 308 may store information related to the EPG database 310, the PSI table 314, and/or the DVR database 316, among other elements or features, such as the alerting module 218 mentioned above. Recorded television programs may be stored using the storage medium 308.

The EPG database 310 may store information related to television channels and the timing of programs appearing on such television channels. Information from the EPG database 310 may be used to inform users of what television channels or programs are available, popular and/or provide recommendations. Information from the EPG database 310 may be used to generate a visual interface displayed by a television that allows a user to browse and select television channels and/or television programs for viewing and/or recording. Information used to populate the EPG database 310 may be received via the network interface 306 and/or via satellites. For example, updates to the EPG database 310 may be received periodically via satellite. The EPG database 310 may serve as an interface for a user to control DVR functions of the PTR 210, and/or to enable viewing and/or recording of multiple television channels simultaneously.

The decoder 326 may convert encoded video and audio into a format suitable for output to a display device. For instance, the decoder 326 may receive MPEG video and audio from the storage medium 308, or the descrambling engine 324, to be output to a television. MPEG video and audio from the storage medium 308 may have been recorded to the DVR database 316 as part of a previously-recorded television program. The decoder 326 may convert the MPEG video and audio into a format appropriate to be displayed by a television or other form of display device and audio into a format appropriate to be output from speakers, respectively. The decoder 326 may be a single hardware element capable of decoding a finite number of television channels at a given time, such as in a time-division arrangement. In the example, eight television channels may be decoded concurrently or simultaneously.

The television interface 312 outputs a signal to a television, or another form of display device, in a proper format for display of video and play back of audio. As such, the television interface 312 may output one or more television channels, stored television programming from the storage medium 308, such as television programs from the DVR database 316 and/or information from the EPG database 310 for example, to a television for presentation.

The PSI table 314 may store information used by the PTR 210 to access various television channels. Information used to populate the PSI table 314 may be received via satellite, or cable, through the tuners 304a-h and/or may be received via the network interface 306 over the network from the service provider 202 shown in FIG. 2. Information present in the PSI table 314 may be periodically or at least intermittently updated. Information that may be present in the PSI table 314 may include: television channel numbers, satellite identifiers, frequency identifiers, transponder identifiers, ECM PIDs (Entitlement Control Message, Packet Identifier), one or more audio PIDs, and video PIDs. A second audio PID of a channel may correspond to a second audio program, such as in another language. In some examples, the PSI table 314 may be divided into a number of tables, such as a NIT (Network Information Table), a PAT (Program Association Table), a PMT (Program Management Table), etc.

Table 1 below provides a simplified example of the PSI table 314 for several television channels. It should be understood that in other examples, many more television channels may be represented in the PSI table 314. The PSI table 314 may be periodically or at least intermittently updated. As such, television channels may be reassigned to different satellites and/or transponders, and the PTR 210 may be able to handle this reassignment as long as the PSI table 314 is updated.

TABLE 1

| Channel | Satellite | Transponder | ECM PID | Audio PIDs | Video PID |
|---|---|---|---|---|---|
| 4 | 1 | 2 | 27 | 2001 | 1011 |
| 5 | 2 | 11 | 29 | 2002 | 1012 |
| 7 | 2 | 3 | 31 | 2003 | 1013 |
| 13 | 2 | 4 | 33 | 2003, 2004 | 1013 |

It should be understood that the values provided in Table 1 are for example purposes only. Actual values, including how satellites and transponders are identified, may vary. Additional information may also be stored in the PSI table 314. Video and/or audio for different television channels on different transponders may have the same PIDs. Such television channels may be differentiated based on which satellite and/or transponder to which a tuner is tuned.

DVR functionality of the PTR 210 may permit a television channel to be recorded for a period of time. The DVR database 316 may store timers that are used by the processors 302 to determine when a television channel should be tuned to and recorded to the DVR database 316 of storage medium 308. In some examples, a limited amount of space of the storage medium 308 may be devoted to the DVR database 316. Timers may be set by the service provider 202 and/or one or more viewers or users of the PTR 210. DVR functionality of the PTR 210 may be configured by a user to record particular television programs. The PSI table 314 may be used by the PTR 210 to determine the satellite, transponder, ECM PID, audio PID, and video PID.

The user interface 318 may include a remote control, physically separate from PTR 210, and/or one or more buttons on the PTR 210 that allows a user to interact with the PTR 210. The user interface 318 may be used to select a television channel for viewing, view information from the EPG database 310, and/or program a timer stored to the DVR database 316 wherein the timer may be used to control the DVR functionality of the PTR 210.

Referring back to the tuners 304a-h, television channels received via satellite may contain at least some encrypted or scrambled data. Packets of audio and video may be scrambled to prevent unauthorized users, such as nonsubscribers, from receiving television programming without paying the service provider 202. When one of the tuners 304a-h is receiving data from a particular transponder of a satellite, the transponder stream may be a series of data packets corresponding to multiple television channels. Each data packet may contain a PID, which in combination with the PSI table 314, can be determined to be associated with a particular television channel. Particular data packets, referred to as ECMs may be periodically transmitted. ECMs may be encrypted; the PTR 210 may use the smart card 322 to decrypt ECMs.

The smart card 322 may function as the CA (Controlled Access) which performs decryption of encryption data to obtain control words that are used to descramble video and/or audio of television channels. Decryption of an ECM may only be possible when the user, e.g., an individual who is associated with the PTR 210, has authorization to access the particular television channel associated with the ECM. When an ECM is received by the demultiplexer 320 and the ECM is determined to correspond to a television channel being stored and/or displayed, the ECM may be provided to the smart card 322 for decryption.

When the smart card 322 receives an encrypted ECM from the demultiplexer 320, the smart card 322 may decrypt the ECM to obtain some number of control words. In some examples, from each ECM received by the smart card 322, two control words are obtained. In some examples, when the smart card 322 receives an ECM, it compares the ECM to the previously received ECM. If the two ECMs match, the second ECM is not decrypted because the same control words would be obtained. In other examples, each ECM received by the smart card 322 is decrypted; however, if a second ECM matches a first ECM, the outputted control words will match; thus, effectively, the second ECM does not affect the control words output by the smart card 322. When an ECM is received by the smart card 322, it may take a period of time for the ECM to be decrypted to obtain the control words. As such, a period of time, such as about 0.2-0.5 seconds, may elapse before the control words indicated by the ECM can be obtained. The smart card 322 may be permanently part of the PTR 210 or may be configured to be inserted and removed from the PTR 210.

The demultiplexer 320 may be configured to filter data packets based on PIDs. For example, if a transponder data stream includes multiple television channels, data packets corresponding to a television channel that are not desired to be stored or displayed by the user may be ignored by the demultiplexer 320. As such, only data packets corresponding to the one or more television channels desired to be stored and/or displayed may be passed to either the descrambling engine 324 or the smart card 322; other data packets may be ignored. For each channel, a stream of video packets, a stream of audio packets and/or a stream of ECM packets may be present, each stream identified by a PID. In some examples, a common ECM stream may be used for multiple television channels. Additional data packets corresponding to other information, such as updates to the PSI table 314, may be appropriately routed by the demultiplexer 320.

The descrambling engine 324 may use the control words output by the smart card 322 in order to descramble video and/or audio corresponding to television channels for storage and/or presentation. Video and/or audio data contained in the transponder data stream received by the tuners 304a-h may be scrambled. The video and/or audio may be descrambled by the descrambling engine 324 using a particular control word. Which control word output by the smart card 322 to be used for successful descrambling may be indicated by a scramble control identifier present within the data packet containing the scrambled video or audio. Descrambled video and/or audio may be output by the descrambling engine 324 to the storage medium 308 for storage, such as part of the DVR database 316 for example, and/or to the decoder 326 for output to a television or other presentation equipment via the television interface 312.

For brevity, the PTR 210 is depicted in a simplified form, and may generally include more or fewer elements or components as desired, including those configured and/or arranged for implementing various features associated with intelligently allocating idle tuner resources to buffer or record broadcast programming determined as desirable, as discussed in the context of the present disclosure. For example, the PTR 210 is shown in FIG. 3 to include the alerting module 218 as mentioned above in connection with FIG. 2. Further, some routing between the various modules of the PTR 210 has been illustrated. Such illustrations are for exemplary purposes only. The state of two modules not being directly or indirectly connected does not indicate the modules cannot communicate. Rather, connections between modules of the PTR 210 are intended only to indicate possible common data routing. It should be understood that the modules of the PTR 210 may be combined into a fewer number of modules or divided into a greater number of modules.

Additionally, although not explicitly shown in FIG. 3, the PTR 210 may include one or more logical modules configured to implement a television steaming media functionality that encodes video into a particular format for transmission over the Internet such as to allow users to remotely view and control a home cable, satellite, or personal video recorder system from an Internet-enabled computer with a broadband Internet connection. The Slingbox® by Sling Media, Inc. of Foster City, Calif., is one example of a product that implements such functionality. Further, the PTR 210 may be configured to include any number of other various components or logical modules that are implemented in hardware, software, firmware, or any combination thereof, and such components or logical modules may or may not be implementation-specific.

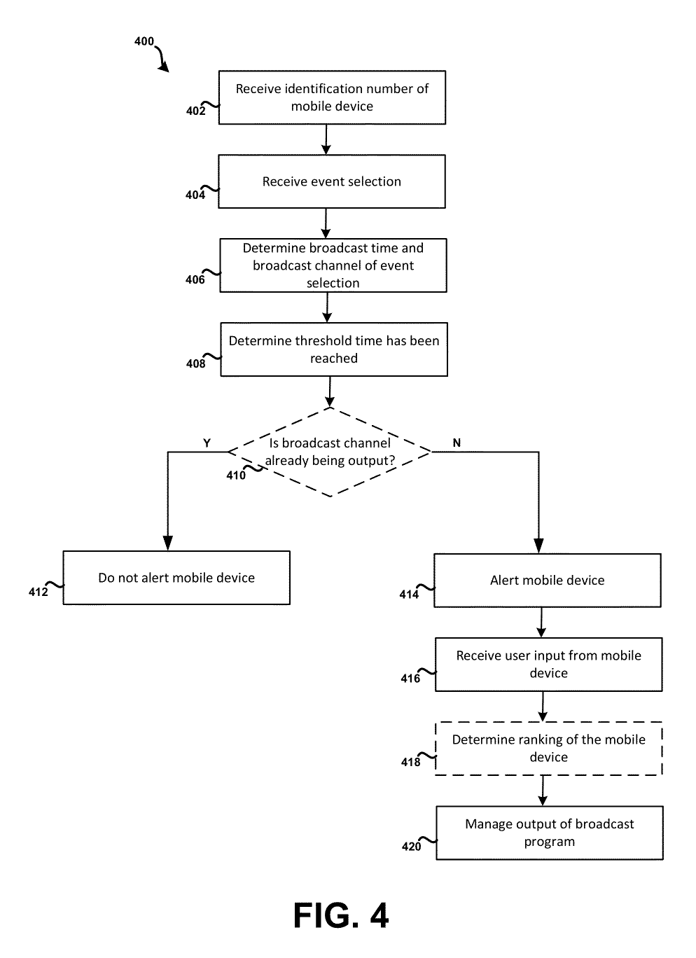

Turning now to FIG. 4, another method 400 that may be performed by the alerting module 218 is shown. It is contemplated that the method 400 comprises example steps that may be presented in a different order, include other steps not shown, and/or include steps that may be optional. The method may include receiving an identification number of the mobile device (step 402), which may include, but is not limited to, computing devices 216a-b of FIG. 2. Merely by way of example, the identification number and/or other pairing details may be obtained at step 402 as described in step 102 of method 100 in FIG. 1 related to Bluetooth pairing. Still further, as described above, step 402 may comprise receiving a plurality of identification numbers related to a plurality of mobile devices. Further, it is noted that one or more preceding steps may occur, in which the alerting module 218 scans an area containing the PTR 210 for possible Bluetooth devices, detects a device, and prompts the device for a connection and/or exchange of connection details, e.g. passkey. It is contemplated that once the identification number is received, it is stored by the alerting module 218 such that future connection attempts may be completed automatically upon detection of the trusted mobile device by the PTR 210.

The method 400 may further comprise receiving an event selection (step 404). The event selection may be received via the mobile device and/or at the PTR 210, or any other computing device that is coupled to the PTR 210. In some examples, receiving the event selection may comprise, or be indicative of, a program title and/or subtitle entered by the user. A plurality of program titles and/or subtitles may be presented to the user for a user selection. Or, a suggested program title and/or subtitle may be presented to the user for user selection. Such suggested program titles and/or subtitles may be determined by the alerting module 218 by predicting user preferences based on current event selections, e.g. content under similar genre, recommendations from social media, recommendations based on location tracking of the user's mobile device, and/or recommendations related to a user's entries in the user's calendar. Other examples are possible.

Further, the user may input one or more threshold times related to the event selection at step 404, such as a duration of time that precedes broadcast of the event selection. If the user prefers to be notified earlier, the threshold time may be lengthened. If the user does not prefer to be notified too far in advance for a particular event selection, the threshold time may be shortened. In other cases, a default threshold time may be implemented for some or all event selections by the user. The threshold time may be input through any computing device and stored by the alerting module 218. Further, the threshold time may be tracked by a timer in the PTR 210 and/or by the service provider. Merely by way of example, the threshold time may be between about 1 minute to about 30 minutes. In another example, the threshold time may be 5 minutes prior to the broadcast time. In yet another example, the threshold time may be about 24 hours prior to the broadcast time. Other examples are possible.

In yet a further aspect, the user may input payment information at step 404 to prepay and/or store payment information for viewing the event selection. For instance, the alerting module 218 may notify the user that a charge will be applied for viewing a movie. The alerting module 218 may inquire if the user would like to pay now or pay later. Further, the alerting module 218 may request payment information that can be stored by the alerting module 218 on a one-time transactional basis or saved for future payments of future charges related to future event selections. Merely by way of example, the user may provide credit card information that the alerting module 218 associates with the event selection and/or the payment information may be associated with a user account. In a different aspect, the user may authorize any charges to be added to a service account of the user by associating the user's service account number with the event selection. In that case, any charges incurred for event selections within a billing cycle may be presented in a single, monthly bill for the user. It is contemplated that charges may be made in advance or during delivery of the desired media content in the event selection. Further, it is contemplated that the alerting module 218 may provide an option for the user to cancel an event selection that requires a fee at any time.

Still referring to FIG. 4, the method 400 may further include determining a broadcast time and/or a broadcast channel of the event selection (step 406). It is contemplated that the alerting module 218 may determine the broadcast information based on at least a portion of the event selection input by the user. For instance, the alerting module 218 may look-up the broadcast time and/or channel based on the program title and/or subtitle. Looking-up may comprise searching through an electronic programming guide (EPG), such as the EPG database 310, or other information, such as the PSI table 314, that is provided by the service provider 202. In some aspects, looking-up may entail establishing a network connection with the service provider 202 to query the service provider 202 for the information, for instance if the EPG does not contain certain future programs and/or if the EPG is not downloaded to the PTR 210. In a different example, the broadcast time and/or broadcast channel is input by the user. In another different aspect, step 406 may determine that the event selection is not scheduled for showing in the foreseeable future. In that case, the alerting module 218 may provide a notice that the program is not available and prompt the user to enter a different event selection. Still further, the alerting module 218 may store and periodically search for the unscheduled event to notify the user at a later date if the alerting module 218 discovers that the unscheduled event becomes scheduled. Even further, the alerting module 218 may communicate the requested unscheduled event to the service provider 202 to notify the service provider 202 that the unscheduled event is desirable. In that way, the service provider 202 may be apprised of desired media content and tailor its future schedule based on popular demand.

Still further, the method 400 may include determining that the threshold time has been reached (step 408). In one example, the alerting module 218 may include a timetable of broadcast times for event selections and threshold times related to the event selections. The alerting module 218 may track the event selections by setting a first timetable entry determined by the threshold time and a second timetable entry based on the broadcast time. Merely by way of example, for an event selection having a threshold time of 10 minutes and a broadcast time of 3 pm on a Monday, the first timetable entry may be 2:50 pm Monday and the second timetable entry may be 3 pm Monday. The alerting module 218 may monitor the first timetable entry first, and upon reaching the first timetable entry or threshold time, the alerting module 218 may track the second timetable entry. In yet another aspect, a third timetable entry may be included comprising a reminder notice, in which if no user input is received in response at any time during the threshold time and/or the broadcast time window, the alerting module 218 may send a reminder message to the mobile device. Other options are possible.

When the threshold time has been reached, the method 400 may determine if the broadcast channel for the event selection is already being output (step 410). For instance, the method may comprise checking if a tuner of the PTR 210 is already being tuned to the broadcast channel that contains, or is scheduled to contain, the desired media content stream. The alerting module 218 may further determine if the particular media content or broadcast channel that contains the particular media content is already being displayed through a specific display device, e.g. television, selected by the user by checking if the display device is on and determining if the images being displayed correspond to the desired media content. If the alerting module 218 determines that the PTR 210 is already outputting or otherwise managing the desired media content at the threshold time, and/or at the broadcast time, then the alerting module 218 may not proceed to step 412 in which no alert is sent to the mobile device. In this way, the alerting module 218 checks if the user is already watching the event selection and if so, no alert needs to be provided. This check, and/or any other steps provided in FIG. 4, may be optional. For instance, a different person may have tuned the PTR 210 to display the broadcast channel during the threshold time and the user may be absent from the display device, in which case receiving the alert may still be desirable. Still, in another aspect, the alerting module 218 may check if the desired media content is already scheduled to be recorded and/or otherwise managed, in which case no alert may be sent and/or an updated alert indicating the scheduled operation is sent.

The method 400 may include alerting the mobile device (step 414) even if the alerting module 218 determines that the broadcast channel is already being output. In another example as illustrated in FIG. 4, the alerting module 218 determines that the broadcast channel is not already being output during the threshold time and/or the broadcast timeframe, e.g. a duration of time that the desired media content is scheduled to be broadcast. In that case, the method 400 proceeds to step 414 to alert the mobile device. As discussed above, the alert may be communicated from the PTR 210 to the mobile device via the Bluetooth or wireless internet connection. The alert may comprise a textual or graphical alert, user interface, and/or menu. In a different example, the alert may comprise audio alerts and/or tactile alerts.

Further, before, after, or during step 414, the alerting module 218 may determine if the mobile device is connected to the PTR 210 and able to receive alerts. If the alerting module 218 determines that the Bluetooth or other wireless connection is not available with the mobile device, the alerting module 218 may provide a secondary means for alerting. For instance, the alerting module 218 may deliver the alert through a different communication address or path, such an email address associated with the user of the mobile device or text message to a phone number associated with mobile device. In a different example, the mobile device and alerting module 218 may communicate through a mobile app or other software. In still other examples, the alerting module 218 may determine not to alert the mobile device after determining that the mobile device is not connected. Such actions may be based on user preference for the particular event selection. For instance, the user may prefer that if the user is not at home where the PTR 210 is located, then no alert should be sent. This determination may be based on whether one or more mobile devices of the user, such as a mobile phone, is within Bluetooth range of the alerting PTR 210.

Still in reference to FIG. 4, the method 400 may include receiving user input from the mobile device (step 416). The user input may be received through a user interface that is presented in the alert and/or in response to the alert sent to the mobile device. It is contemplated that the user input may comprise instructions for managing output of the event selection. Merely by way of example, the alerting module 218 may receive user input from the mobile device to record, pause, play on a particular device, or skip output of the event selection, and subsequently implement the user input during the threshold time and/or when the broadcast time is reached. It is contemplated that the alerting module 218 receives the user input through the same Bluetooth or wireless connection established for sending the alert. Other operational modes may be implemented based on the user input. For instance, if no user input is received within a particular time period, the reminder notice as described above may be sent to the mobile device. The reminder notice may comprise a second alert that is an updated message indicating that the broadcast program has started. Further, the alerting module 218 may instruct the PTR 210 to implement a default mode. Such modes may comprise predetermined operations based on previous user input and may include recording the event selection.

In other examples, a plurality of mobile devices may be notified for a single event selection and/or a plurality of user input from the different mobile devices may be received in response to the alert. In those cases, the method 400 may determine a ranking of the mobile devices and/or input received therefrom (step 418). For instance, the alerting module 218 may include a prioritization scheme for the different mobile devices such that input from a higher-ranked mobile device may override input from a lower-ranked mobile device. This feature may be utilized as a parental control measure. In another example, event selections may conflict and broadcast times may overlap. In that case, the alerting module 218 may alert the mobile device(s) and/or implement user input instructions based on the priorities of the mobile devices associated with the conflicting event selections. Merely by way of example, if an event selection associated with a higher-ranked mobile device is already being output by the display device associated with the PTR 210 and a second event selection associated with a lower-ranked, second mobile device is about to occur, the alerting module 218 may notify the lower-ranked mobile device that another event selection is currently active and provide an option for recording the event selection rather than displaying the event selection. In another example, the alerting module 218 may recommend to the user to watch the desired broadcast program on a different display device that is not occupied, such as a different television and/or the user's own mobile device. In any case, it is contemplated that the alerting module 218 manages output of the broadcast program (step 420) based on the user input received, or not received.

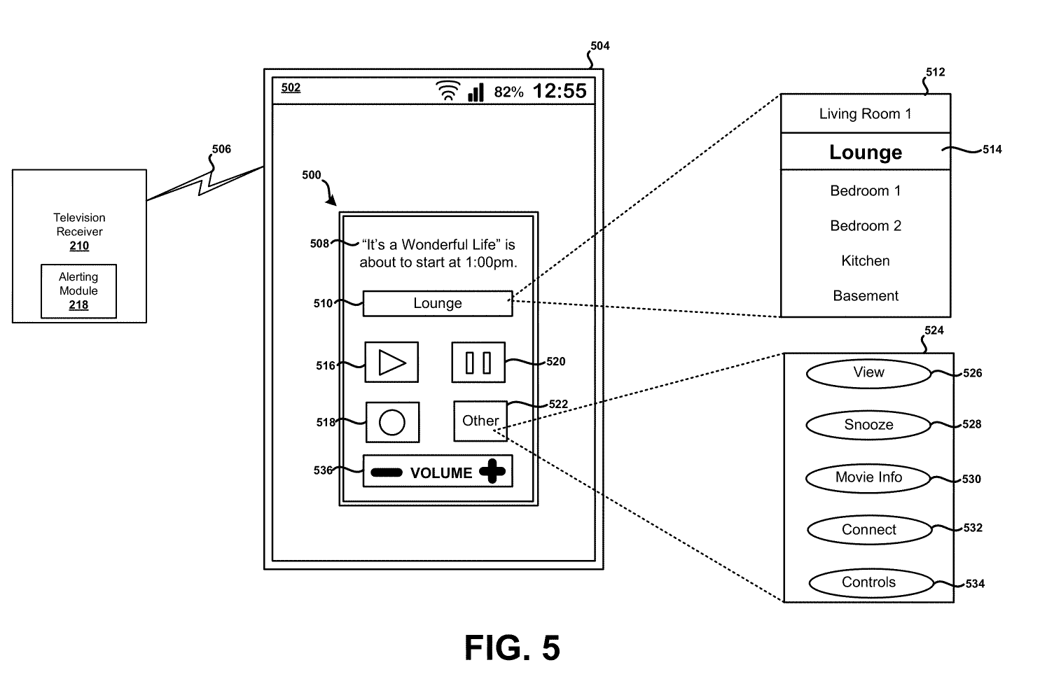

Turning now to FIG. 5, an example user interface 500 in connection with the alerting module 218 is shown on a display screen 502 of an example mobile device 504, such as a mobile phone. It is contemplated that the alert sent by the alerting module 218 at step 414 of FIG. 4 and/or at step 108 of FIG. 1 comprises at least a portion of the user interface 500. The user interface 500 may be provided by the alerting module 218 of the PTR 210 through connection 506, which may represent the Bluetooth or wireless internet connection. As shown in FIG. 5, the user interface 500 may include a message 508 that the event selection is about to start. Merely by way of example, the message 508 may contain a program title, such as “It's a Wonderful Life” and a broadcast time, such as “1:00 pm” as shown in FIG. 5. In one example, a countdown clock or minutes remaining until the broadcast time is provided in the message 508 such that the message 508 is dynamically updated.

As further shown in FIG. 5, the user interface 500 may provide options for receiving input from the user. For instance, a display device selection box 510 may show a currently selected display device, such as a television screen located in a “Lounge”. Upon clicking on, touching, or otherwise selecting the display device selection box 510, one or more additional windows or drop-down menus may appear to show a display devices list 512. The display devices list 512 may allow the user to highlight 514 or otherwise select one or more display devices in various rooms of a house where the event selection will be managed and/or output through.

The user interface 500 of FIG. 5 further shows various operational buttons 516-522 that may be selected by the user. Selection of a play button 516 may output the event selection on the display device(s) shown in the display device selection box 510. For instance, the alerting module 218 may turn on a television screen of a television located in the “Lounge” and/or tune to the broadcast channel containing the desired media content. Selection of a record button 518 may cause the PTR to record the broadcast program. The recorded program may be saved in the storage medium 308 of the PTR 210. It is contemplated that several operations may be performed simultaneously, for instance, in response to the user selecting both the play button 516 and the record button 518. The user interface 500 may further provide a pause button 520 that pauses output of the broadcast program and/or temporarily records a portion of it until a user is able to watch or resume the program. For instance, the user may select the pause button 520 so that the television tuner is tuned to the broadcast channel and the display device shown in the display device selection box 510 is ready to present the desired media content. The alerting module 218 may instruct the PTR 210 to record the media content until the user returns and unpauses, via the pause button 520 or otherwise, the media content.

Still further, as shown in FIG. 5, an “Other” button 522 may be presented on the user interface 500 that upon selection opens to an options list 524. The options list 524 may include a variety of options, such as, and merely by way of example, a view button 526 to allow the desired media content to be viewed through the mobile device 504. The desired media content may be provided to the mobile device 504 through the Bluetooth or wireless connection 506. A snooze button 528 may allow the alarm to be paused for a minute or other duration of time before subsequent alerts are sent again to the mobile device 504. A movie information button 530 may open to further windows to show information on other broadcast times that are available for the desired broadcast program. The user may select the other broadcast times to set up additional event selections. In another example, the movie information button 530 may provide, upon selection, information related to the production, cast, and/or links to other sources related to the broadcast content. Still further, a connect button 532 may be provided to facilitate communication of the event selection with friends and family through social media and messaging tools. For instance, the connect button 532 may allow the user to post a message on a social media site that the broadcast program is about to start. In another aspect, the connect button 532 may permit the user to send an automatically-generated notification message to a plurality of mobile devices to inform the plurality of mobile devices that the desired media content is viewable at a broadcast time and a broadcast channel. Even further, a controls button 534 may be provided to receive further user input for services provided by the alerting module 218. Merely by way of example, the controls button 534 may allow the user to adjust parental controls settings, payment and/or credit card information, threshold time selection, and so on. In another aspect, the user interface 500 may provide a list of requested media content by the user and/or other suggested media content. Other examples are possible. Further, as shown in FIG. 5, a volume button 536 may be provided to control the volume of the selected display device in the display device selection box 510. Other examples are possible.

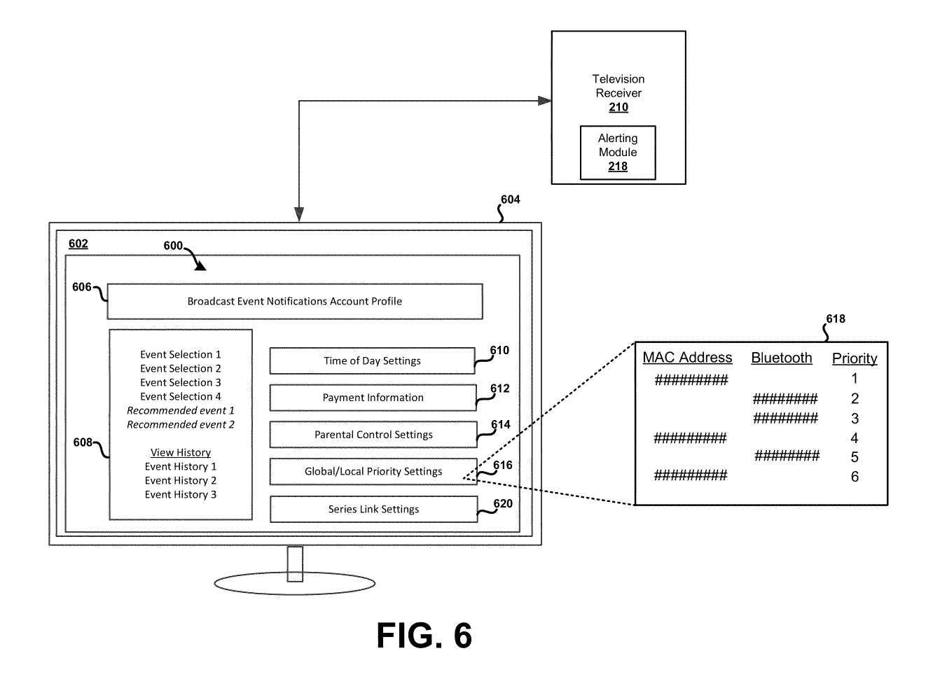

Turning now to FIG. 6, another example user interface 600 is provided. It is contemplated that the user interface 600 is provided on a display screen 602 of an example display device 604 by the alerting module 218 of the PTR 210. The user interface 600 may include account information 606, such as a profile username for a specific user and/or a general notifications account header. It is noted that the specific user may have more than one mobile device set up to receive alerts at any one time. For instance, a mobile phone and a tablet computer linked to the username of the specific user may both receive notifications for a broadcast program to begin. It is contemplated that one or more of the devices receiving the notifications may also receive user input for managing the broadcast program.

An event selection list 608 may show upcoming broadcast programs or event selections, or a single event selection. The event selection list 608 may also include a name or identification number of a mobile device to be alerted for each event selection. Further, the event selection list 608 may show one or more recommended broadcast program events, in which the user may select and alter their status to be included as event selections. In another aspect, the event selection list 608 may show a view history listing previously alerted broadcast programs or event selections, which may be highlighted and/or otherwise selected to reactivate alerts on the same broadcast programs scheduled for the future. The user interface 600 may further include a time of day settings 610 that allows the user to adjust for periods of the day in which the broadcast event notifications may be on or off. For instance, the user may set any notifications scheduled for evening times to be off for a particular week, month, weekday or weekend for a particular mobile device.

The user interface 600 may further include payment information 612 option to receive user input regarding a credit card and/or billing account linkage to the notifications account. A parental controls settings 614 may be provided to allow a user to create filters for the media content that may be applicable for a child's user profile. The parental controls settings 614 may be password protected and/or a feature that is accessible only by a mobile device of an authorized user, e.g. parent. In another aspect, a priority settings 616 option is provided to allow the user to organize or rank a plurality of mobile devices. For instance, a priority window 618 may provide a listing of identification numbers, such as MAC addresses and/or Bluetooth numbers, and an associated priority ranking. As described above, the broadcast event notifications system provided by the alerting module 218 may manage output of the desired media content based, at least in part, on the rankings.

In another aspect, it is contemplated that the user interface 600 may provide a series link option 620 that allows the user to select recurring notifications for a broadcast event series, such as a season of a television show, such that alert notifications are provided by the alerting module 218 for each episode as they are aired continuously throughout the season. In another example, upon selection of a broadcast event that is a part of a series, the alerting module 218 may prompt the user whether a series link should be established or if notifications should be provided for the single selected broadcast event only. In a different aspect, the series link option 620 may allow the user to receive alerts regarding a new series or upcoming season and whether the series link notifications should continue for the upcoming series events. For instance, the alerting module 218 may detect an end of a first series of broadcast events. After detecting the end of the first series of broadcast events, the alerting module 218 may prompt the user at any time prior to the beginning of the new series of broadcast events if the user is still interested in continuing to receive alerts on the new series. In this way, the user may be informed of the new, upcoming events and the alerting module 218 may continue its notifications services.

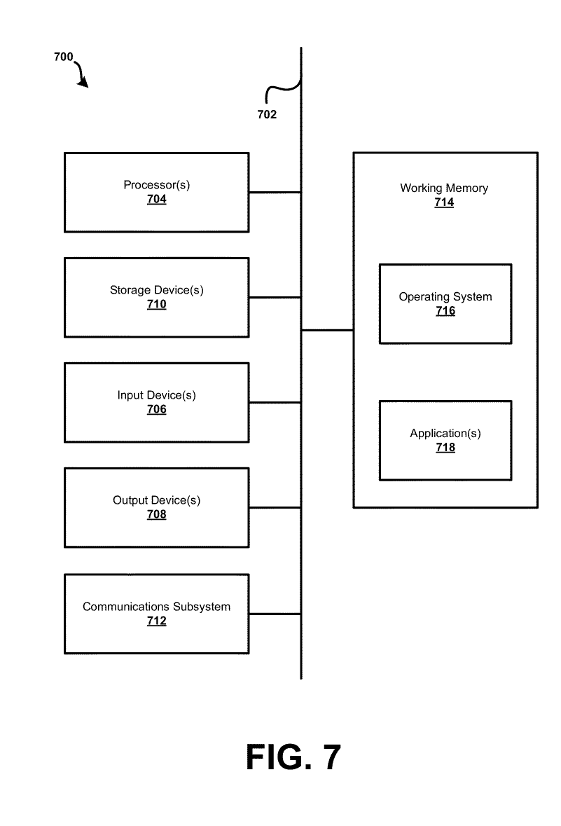

FIG. 7 shows an example computer system or device 700 in accordance with the disclosure. An example of a computer system or device includes an enterprise server, blade server, desktop computer, laptop computer, tablet computer, personal data assistant, smartphone, gaming console, STB, television receiver, and/or any other type of machine configured for performing calculations. Any particular one of the previously-described computing devices may be wholly or at least partially configured to exhibit features similar to the computer system 700, such as any of the respective elements of at least FIG. 2. In this manner, any of one or more of the respective elements of at least FIG. 2 may be configured to perform and/or include instructions that, when executed, perform the method of FIG. 1 and/or the method of FIG. 4. Still further, any of one or more of the respective elements of at least FIG. 1 may be configured to perform and/or include instructions that, when executed, instantiate and implement functionality of the PTR 210 and/or the server(s).

The computer device 700 is shown comprising hardware elements that may be electrically coupled via a bus 702 (or may otherwise be in communication, as appropriate). The hardware elements may include a processing unit with one or more processors 704, including without limitation one or more general-purpose processors and/or one or more special-purpose processors (such as digital signal processing chips, graphics acceleration processors, and/or the like); one or more input devices 706, which may include without limitation a remote control, a mouse, a keyboard, and/or the like; and one or more output devices 708, which may include without limitation a presentation device (e.g., television), a printer, and/or the like.

The computer system 700 may further include (and/or be in communication with) one or more non-transitory storage devices 710, which may comprise, without limitation, local and/or network accessible storage, and/or may include, without limitation, a disk drive, a drive array, an optical storage device, a solid-state storage device, such as a random access memory, and/or a read-only memory, which may be programmable, flash-updateable, and/or the like. Such storage devices may be configured to implement any appropriate data stores, including without limitation, various file systems, database structures, and/or the like.

The computer device 700 might also include a communications subsystem 712, which may include without limitation a modem, a network card (wireless and/or wired), an infrared communication device, a wireless communication device and/or a chipset such as a Bluetooth™ device, 802.11 device, WiFi device, WiMax device, cellular communication facilities such as GSM (Global System for Mobile Communications), W-CDMA (Wideband Code Division Multiple Access), LTE (Long Term Evolution), etc., and/or the like. The communications subsystem 712 may permit data to be exchanged with a network (such as the network described below, to name one example), other computer systems, and/or any other devices described herein. In many embodiments, the computer system 900 will further comprise a working memory 714, which may include a random access memory and/or a read-only memory device, as described above.

The computer device 700 also may comprise software elements, shown as being currently located within the working memory 714, including an operating system 716, device drivers, executable libraries, and/or other code, such as one or more application programs 718, which may comprise computer programs provided by various embodiments, and/or may be designed to implement methods, and/or configure systems, provided by other embodiments, as described herein. By way of example, one or more procedures described with respect to the method(s) discussed above, and/or system components might be implemented as code and/or instructions executable by a computer (and/or a processor within a computer); in an aspect, then, such code and/or instructions may be used to configure and/or adapt a general purpose computer (or other device) to perform one or more operations in accordance with the described methods.

A set of these instructions and/or code might be stored on a non-transitory computer-readable storage medium, such as the storage device(s) 710 described above. In some cases, the storage medium might be incorporated within a computer system, such as computer system 700. In other embodiments, the storage medium might be separate from a computer system (e.g., a removable medium, such as flash memory), and/or provided in an installation package, such that the storage medium may be used to program, configure, and/or adapt a general purpose computer with the instructions/code stored thereon. These instructions might take the form of executable code, which is executable by the computer device 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer device 700) to perform methods in accordance with various embodiments of the disclosure. According to a set of embodiments, some or all of the procedures of such methods are performed by the computer system 700 in response to processor 704 executing one or more sequences of one or more instructions (which might be incorporated into the operating system 716 and/or other code, such as an application program 718) contained in the working memory 714. Such instructions may be read into the working memory 714 from another computer-readable medium, such as one or more of the storage device(s) 710. Merely by way of example, execution of the sequences of instructions contained in the working memory 714 may cause the processor(s) 704 to perform one or more procedures of the methods described herein.

The terms “machine-readable medium” and “computer-readable medium,” as used herein, may refer to any non-transitory medium that participates in providing data that causes a machine to operate in a specific fashion. In an embodiment implemented using the computer device 700, various computer-readable media might be involved in providing instructions/code to processor(s) 704 for execution and/or might be used to store and/or carry such instructions/code. In many implementations, a computer-readable medium is a physical and/or tangible storage medium. Such a medium may take the form of a non-volatile media or volatile media. Non-volatile media may include, for example, optical and/or magnetic disks, such as the storage device(s) 710. Volatile media may include, without limitation, dynamic memory, such as the working memory 714.

Example forms of physical and/or tangible computer-readable media may include a floppy disk, a flexible disk, hard disk, magnetic tape, or any other magnetic medium, a compact disc, any other optical medium, ROM, RAM, and etc., any other memory chip or cartridge, or any other medium from which a computer may read instructions and/or code. Various forms of computer-readable media may be involved in carrying one or more sequences of one or more instructions to the processor(s) 704 for execution. By way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 712 (and/or components thereof) generally will receive signals, and the bus 702 then might carry the signals (and/or the data, instructions, etc. carried by the signals) to the working memory 714, from which the processor(s) 704 retrieves and executes the instructions. The instructions received by the working memory 714 may optionally be stored on a non-transitory storage device 710 either before or after execution by the processor(s) 704.

It should further be understood that the components of computer device 700 can be distributed across a network. For example, some processing may be performed in one location using a first processor while other processing may be performed by another processor remote from the first processor. Other components of computer system 700 may be similarly distributed. As such, computer device 700 may be interpreted as a distributed computing system that performs processing in multiple locations. In some instances, computer system 700 may be interpreted as a single computing device, such as a distinct laptop, desktop computer, or the like, depending on the context.

The methods, systems, and devices discussed above are examples. Various configurations may omit, substitute, or add various method steps or procedures, or system components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those of skill with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Furthermore, the example embodiments described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A television receiver for alerting a plurality of mobile devices about a broadcast television event, comprising:
one or more processors; and
a memory communicatively coupled with and readable by the one or more processors and having stored therein processor-readable instructions that, when executed by the one or more processors, cause the one or more processors to:
pair the plurality of mobile devices to be alerted with the television receiver;
receive an event selection, wherein the event selection is indicative of a program title related to a broadcast program to be alerted to the plurality of mobile devices;
determine a broadcast time and a broadcast channel of the broadcast program, wherein a program stream of the broadcast program is scheduled to be received at the broadcast channel during the broadcast time;
determine that a threshold time prior to the broadcast time has been reached;
after determining that the threshold time has been reached, simultaneously alert the plurality of mobile devices with 1) a message indicating that the broadcast program is about to start and 2) a request for user input from at least one of the plurality of mobile devices;
after alerting the plurality of mobile devices, receive the user input from at least one of the plurality of mobile devices; and
after receiving the user input, manage output of the broadcast program based on the user input.

2. The television receiver of claim 1, wherein at least one of the plurality of mobile devices comprises a mobile phone or a tablet computer.

3. The television receiver of claim 1,
wherein the plurality of mobile devices are associated with a user profile; and
the alert the plurality of mobile devices operation alerts the plurality of mobile devices associated with the user profile.

4. The television receiver of claim 1, further having stored therein processor-readable instructions that, when executed by the one or more processors, cause the one or more processors to:
determine the broadcast time of the broadcast program by looking up at least a portion of the received event selection in an electronic program guide;
display a plurality of broadcast times for the event selection; and
receive a user selection for at least one of the plurality of displayed broadcast times for alerting the plurality of mobile devices.

5. The television receiver of claim 1, further having stored therein processor-readable instructions that, when executed by the one or more processors, cause the one or more processors to:
receive a subtitle related to the broadcast program in the event selection; and
look up at least one of the program title and the subtitle in the electronic program guide.

6. The television receiver of claim 1, further having stored therein processor-readable instructions that, when executed by the one or more processors, cause the one or more processors to:
receive a user selection for the threshold time, wherein the threshold time is a duration of time immediately preceding the broadcast time.

7. The television receiver of claim 1, further having stored therein processor-readable instructions that, when executed by the one or more processors, cause the one or more processors to:
receive an output command selected in the user input;
receive a display device selection in the user input;
tune to the broadcast channel to receive the program stream at the broadcast time; and
output the broadcast program on the selected display device.

8. The television receiver of claim 1, further having stored therein processor-readable instructions that, when executed by the one or more processors, cause the one or more processors to:
determine that the broadcast channel is not being output on a display device coupled to the television receiver during the threshold time; and
after determining that the display device is not displaying the broadcast channel, alert, by the television receiver, at least one of the plurality of mobile devices based on the determination that the display device is not displaying the broadcast channel.

9. The television receiver of claim 8, wherein the display device is a predetermined display device based on a previous user input.

10. The television receiver of claim 1, further having stored therein processor-readable instructions that, when executed by the one or more processors, cause the one or more processors to:
send a second alert to the plurality of mobile devices if no user input is received once the broadcast time is reached, wherein the second alert comprises an updated message indicating that the broadcast program has started; and
manage output of the broadcast program based on a default mode, wherein the default mode is a predetermined operation based on a previous user input.

11. The television receiver of claim 1, further having stored therein processor-readable instructions that, when executed by the one or more processors, cause the one or more processors to:
alert the plurality of mobile devices at an identification number through a Bluetooth or wireless connection.

12. The television receiver of claim 1, further having stored therein processor-readable instructions that, when executed by the one or more processors, cause the one or more processors to:
rank the plurality of mobile devices based on a user-determined priority; and
manage output of the broadcast program based on the user input received from a highest-ranking mobile device.

13. A method for alerting mobile devices about a broadcast television event, comprising:
establishing, by a television receiver, a first communication link with a first mobile device and a second communication link with a second mobile device, wherein the first communication link comprises a local wireless connection between the first mobile device and the television receiver and the second communication link comprises a local wireless connection between the second mobile device and the television receiver;
receiving, by the television receiver, an event selection, wherein the event selection is indicative of a program title related to a broadcast program to be alerted to the first and second mobile devices;
determining, by the television receiver, that a threshold time prior to a broadcast time of the event selection has been reached; and
after determining that the threshold time prior to the broadcast time has been reached, simultaneously alerting, by the television receiver, the first mobile device through the first communication link and the second mobile device through the second communication link.

14. The method of claim 13, further comprising:
after determining that the threshold time prior to the broadcast time has been reached, determining, by the television receiver, that a tuner of the television receiver is already tuned to a broadcast channel containing the broadcast program.

15. The method of claim 13, further comprising:
after determining that the threshold time prior to the broadcast time has been reached, determining, by the television receiver, that a display device coupled to the television receiver is not displaying a broadcast channel scheduled to display the broadcast program at a broadcast time; and
after determining that the display device is not displaying the broadcast program, alerting, by the television receiver, at least the first mobile device based on the determination that the display device is not displaying the broadcast channel.

16. The method of claim 13, further comprising:
outputting, by the television receiver, a user interface for presentation on a display device coupled to the television receiver, wherein the user interface comprises an event selection list including an upcoming event selection, a previously alerted event selection, and a recommended broadcast event selection.

17. A non-transitory processor-readable medium for alerting a plurality of mobile devices about a broadcast event, comprising processor-readable instructions configured to cause one or more processors to:
pair the plurality of mobile devices to be alerted with the television receiver;
receive an event selection, wherein the event selection is indicative of a program title related to a broadcast program to be alerted to the plurality of mobile devices;
determine a broadcast time and a broadcast channel of the broadcast program, wherein a program stream of the broadcast program is scheduled to be received at the broadcast channel during the broadcast time;
determine that a threshold time prior to the broadcast time has been reached;
after determining that the threshold time has been reached, simultaneously alert the plurality of mobile devices with 1) a message indicating that the broadcast program is about to start and 2) a request for user input from at least one of the plurality of mobile devices;
after alerting the plurality of mobile devices, receive the user input from at least one of the plurality of mobile devices; and
after receiving the user input, manage output of the broadcast program based on the user input.

18. The non-transitory processor-readable medium for alerting the plurality of mobile devices of claim 17, wherein the processor-readable instructions further comprise processor-readable instructions configured to:
receive a user input through at least one of the plurality of mobile devices to select a display device from a plurality of display devices for displaying the broadcast channel.

19. The non-transitory processor-readable medium for alerting the plurality of mobile devices of claim 17, wherein the processor-readable instructions further comprise processor-readable instructions configured to cause the one or more processors to:
detect that the broadcast program is related to a series of broadcast programs; and
provide a series link for the series of broadcast programs, wherein the series link establishes recurring notifications for the series of broadcast programs.

20. The non-transitory processor-readable medium for alerting the plurality of mobile devices of claim 17, wherein the processor-readable instructions further comprise processor-readable instructions configured to cause the one or more processors to:
after determining that the threshold time has been reached, determine that a display device coupled to the television receiver is not displaying the broadcast channel; and
after determining that the display device is not displaying the broadcast channel, alert at least one of the plurality of mobile devices based on the determination that the display device is not displaying the broadcast channel.
